(19) United States
(12) Patent Application Publication
(10) Pub. No.: US 2011/0117867 A1
(43) Pub. Date: May 19, 2011

(54) RECEIVED SIGNAL STRENGTH INDICATOR APPARATUS AND METHOD

(75) Inventor: Ron Fridman, Paoli, PA (US)

(73) Assignee: USA Technologies, Inc., Malvern, PA (US)

(21) Appl. No.: 12/618,189

(22) Filed: Nov. 13, 2009

(51) Int. Cl. H04B 17/00

(52) U.S. Cl. 455/226.2

(57) ABSTRACT

Received signal strength indicator apparatus and methods are disclosed. A received signal strength indicator includes a modem, a display, a processor, and a step-up converter. The modem is configured to receive a signal. The processor is coupled to the modem and the display. The processor is configured to determine a strength of the signal and to indicate the strength of the signal on the display. The step-up converter is coupled to one of the modem, the processor, and the display. The step-up converter is configured to step-up the voltage of a power source to power the one of the modem, the processor, and the display. The received signal strength indicator is usable for determining a location for installing a vending machine. The location for installing the vending machine is selected based on the strength of the received signal.

### FIELD OF THE INVENTION

The present invention relates to the field of signal detection, and more particularly to indicating received signal strength.

### BACKGROUND OF THE INVENTION

Many vending machines include components enabling them to wirelessly communicate with cellular telephone networks. Those vending machines must be installed in locations where they receive a signal from cell phone towers. When installing such vending machines, it may be desirable to know the signal strength in a location to determine whether it is suitable for vending machine installation. Accordingly, there is an ever-present need for improved received signal strength indicators.

### SUMMARY OF THE INVENTION

The present invention is embodied in received signal strength indicator apparatus and methods. According to an aspect of the present invention, a received signal strength indicator apparatus is disclosed. The received signal strength indicator includes a modem, a display, a processor, and a step-up converter. The modem is configured to receive a signal. The processor coupled to the modem and zo the display. The processor is configured to determine a strength of the signal and to indicate the strength of the signal on the display. The step-up converter is coupled to one of the modem, the processor, and the display. The step-up converter is configured to step-up the voltage of a power source to power the one of the modem, the processor, and the display.

According to another aspect of the present invention, a method for determining a location for installing a vending machine is disclosed. The method includes providing an apparatus having a modem and an antenna. The modem corresponds to a modem of the vending machine and the antenna corresponds to an antenna of the vending machine. The method further includes receiving a signal with the modem. The method further includes determining a strength of the signal. The method further includes selecting the location for installing the vending machine based on the strength of the signal.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. This emphasizes that according to common practice, the various features of the drawings are not drawn to scale. On the contrary, the dimensions of the various features are arbitrarily expanded or reduced for clarity. Included in the drawings are the following figures:

FIG. 1 is a block diagram depicting an exemplary received signal strength indicator apparatus accordance with an aspect of the present invention;

FIG. 2 is an exemplary display for the received signal strength indicator apparatus of FIG. 1;

FIG. 3 is a flow chart of exemplary steps for determining the location for installing a vending machine in accordance with an aspect of the present invention; and

FIG. 4 is a flow chart of exemplary steps for selecting a source of the signal for the determination of signal strength in accordance with an aspect of the present invention.

### DETAILED DESCRIPTION OF THE INVENTION

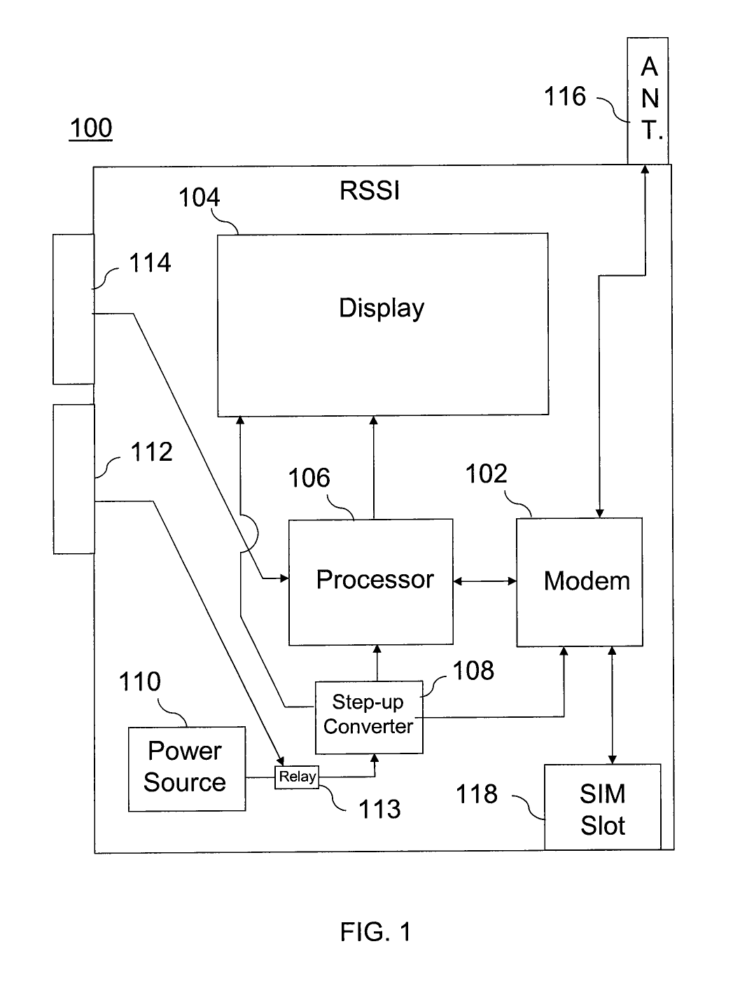

FIG. 1 depicts an exemplary received signal strength indicator (RSSI) apparatus 100 in accordance with one aspect of the present invention. As described herein, the received signal strength is defined as a measurement of the power present in a received radio signal. The received radio signal may be, for example, a signal from a cellular telephone network that is broadcast from a cell phone tower. Although the apparatus and methods described below refer to signals received by vending machines, it is contemplated that aspects of the present invention may be used to determine the received signal strength from any source without departing from the spirit and scope of the present invention.

As a general overview, apparatus 100 includes a modem 102, a display 104, a processor 106, and a step-up converter 108. Apparatus 100 may be a handheld apparatus. Additional details of apparatus 100 are provided below.

Modem 102 receives a signal. The signal may be any signal for which an indication of the received signal strength is desired. In an exemplary embodiment, modem 102 is configured to receive a signal from a source, e.g., a cell phone tower. The source may be any signal source or may be preselected, as will be described herein. Modem 102 may desirably correspond to a modem commonly included in a vending machine (not shown), in order to accurately determine the strength of a signal likely to be received by the modem of the vending machine. A suitable modem 102 for use with apparatus 100 is the GC864 manufactured by Telit Communications PLC (headquartered in Rome, Italy). Other suitable modems 102 will be understood by one of ordinary skill in the art from the description herein.

Display 104 displays a received signal strength. In an exemplary embodiment, display 104 displays the received signal strength of the signal received by modem 102. Display 104 may desirably continuously update the received signal strength being displayed. Display 104 may desirably indicate the received signal strength in multiple formats, as will be described herein. Display 104 may further indicate the bit error rate of the signal. Display 104 may be an LCD display. Other suitable displays 104 will be understood by one of ordinary skill in the art from the description herein.

Processor 106 determines the strength of the received signal and indicates the received signal strength on display 104. Processor 106 is coupled to modem 102 and display 104. In an exemplary embodiment, processor 106 receives electronic data from modem 102. The received electronic data represents the signal received by modem 102. Processor 106 processes the received electronic data to determine a strength of the signal received by modem 102. Processor 106 then transmits electronic data to display 104. The transmitted electronic data represents the received signal strength of the signal received by modem 102. Processor 106 may be configured to continuously provide the received signal strength for display on display 104. A suitable processor 106 for use with apparatus 100 is a PIC16 8-bit microcontroller manufactured by Microchip Technology (headquartered in Chandler, Ariz., USA). Other suitable processors 106 will be understood by one of ordinary skill in the art from the description herein.

Step-up converter 108 is configured to step up the voltage of a power source. In an exemplary embodiment, step-up converter 108 is coupled to one or more of modem 102, display 104, and processor 106. Step-up converter 108 steps-up the voltage from a power source 110 in order to power one or more of modem 102, display 104, and processor 106. Step-up converter 108 may be configured to provide a voltage suitable for powering modem 102, display 104, and/or processor 106. Step-up converter 108 may step up the voltage from power source 110 in one or multiple stages. A suitable step-up converter 108 for use with apparatus 100 is the LTC3533 DC/DC converter manufactured by Linear Technology (headquartered in Milpitas, Calif., USA). Other suitable step-up converters 108 will be understood by one of ordinary skill in the art from the description herein.

Apparatus 100 may also include or be configured to receive a power source 110. In an exemplary embodiment, power source 110 is coupled to step-up converter 108 and is configured to provide a voltage to step-up converter 108. Thereby, power source 110 is configured to power one or more of modem 102, display 104, and processor 106 via step-up converter 108. Power source 110 may also be configured to directly power one or more of modem 102, display 104, and processor 106. Examples of suitable power sources 110 for apparatus 100 will be described herein.

In an exemplary embodiment, a conventional modem for use as modem 102 is designed to operate at 3.8 volts. However, it may be more cost-effective for power source 110 to provide less than 3.8 volts. For one example, power source 110 may be a 3 volt power source, e.g., a 3 volt lithium battery. A 3 volt lithium battery may provide a particularly suitable and cost-effective power source for apparatus 100. A 3 volt power source may provide about 3 volts, e.g., between 2.9-3.1 volts, for powering the components of apparatus 100. Accordingly, step-up converter 108 may be configured to step up the 3 volts provided by power source 110 in order to supply modem 102 with about 3.8 volts, e.g., between 3.7-3.9 volts, in order to power modem 102.

For another example, power source 110 may be a 2.4 volt power source, e.g., a power source comprising two AA batteries and a super capacitor. Two AA batteries may provide a particularly suitable and cost-effective power source for apparatus 100. A 2.4 volt power source may provide about 2.4 volts, e.g., between 2.3-2.5 volts, for powering the components of apparatus 100. Accordingly, step-up converter 108 may be configured to step up the 2.4 volts provided by power source 110 in order to supply modem 102 with about 3.8 volts, e.g., between 3.7-3.9 volts, in order to power modem 102.

It will be understood that the specific voltages provided for exemplary power source 110 are illustrative and not limiting. Power source 110 may comprise a power source supplying any number of volts.

The use of a power source 110 that provides less than 3.8 volts provides apparatus 100 with a cost-effective source of power in relation to conventional devices. As described above, a conventional modem for use as modem 102 may operate at 3.8 volts. However, a conventional 3.8 volt power source may be costly in comparison to power sources providing lower voltages. Thus, inclusion of step-up converter 108 enables the use of lower voltage power sources, allowing operation of apparatus 100 with a power source that is lower in cost. Modems, such as modem 102, are typically used in devices where it is desirable to maximize battery life, e.g., in cellular telephones to maximize stand-by and talk time. The use of a lower voltage power source such as those described herein along with the inclusion of a step-up converter to power a modem in a device such as a cellular telephone would increase the power draw, thereby undesirably decreasing the life of the power source. However, it has been discovered by the inventor that apparatus 100 as described herein may effectively display received signal strength indications over a prolonged period despite the increased power drawn from power source 110 due to the inclusion of step-up converter 108. This is because apparatus 100 need only be operated for short durations to provide the received signal strength and/or bit error rate necessary for typical installations of vending machines or devices having modems for wireless communication. Operating apparatus 100 for short durations substantially increase the lifespan of power source 110.

Apparatus 100 may include a power button 112. Power button 112 may be coupled to a power relay 113. Power relay 113 may be coupled between power source 110 and one of the modem 102, display 104, and processor 106. Power relay 113 may optionally be coupled between power source 110 and step-up converter 108. In an exemplary embodiment, power button 112 controls power relay 113. For example, when power button 112 is actuated, power relay 113 couples power source 110 to step-up converter 108. Thus, actuation of power button 112 enables power source 110 to provide power to modem 102, display 104, and/or processor 106 via step-up converter 108. It may be desirable for power source 110 to provide power for only a predetermined period of time, e.g., one or two minutes, following actuation of power button 112. Thus, upon actuation of power button 112, is power relay 113 may couple the power source 110 to step-up converter 108 for a predetermined period of time, and then uncouple power source 110. This will result in apparatus 100 drawing power from power source 110 for only a short duration. Actuation of the power button 112 during this predetermined period of time may reset the predetermined period of time for coupling power source 110 to step-up converter 108.

Apparatus 100 may also include a hold button 114. Hold button 114 may be coupled to processor 106. In an exemplary embodiment, hold button 114 controls what is displayed by processor 106 on display 104. For example, when hold button 114 is actuated, processor 106 continues to display the received signal strength currently indicated on display 104 for a predetermined period of time. In other words, when the hold button 114 is actuated, a “Hold” mode is entered, and the received signal strength being shown on display 104 is frozen for a predetermined period of time, rather than being updated. Freezing the displayed signal strength on display 104 may be desirable for allowing a user to observe a received signal strength when apparatus 100 is in an area where display 104 cannot be viewed, e.g., behind a vending machine. Actuation of the hold button 114 during the predetermined period of time may cause apparatus 100 to return to a normal mode of operation. Additionally, actuation of the hold button at any time may reset the predetermined period of time for coupling power source 110 to step-up converter 108, as described above with respect to power button 112.

Apparatus 100 may also include an antenna 116. In an exemplary embodiment, antenna 116 is coupled to modem 102. Antenna 116 may receive the signal from the source and transmit the received signal to modem 102. Antenna 116 may desirably correspond to an antenna commonly included in a vending machine, in order to accurately determine the strength of a signal likely to be received by the modem of the vending machine via the antenna. Suitable antennae for use with apparatus 100 will be understood by one of ordinary skill in the art from the description herein.

Apparatus 100 may also include a Subscriber Identity Module (SIM) card slot 118. In an exemplary embodiment, SIM card slot 118 is configured to receive a SIM card. SIM card slot 118 is coupled to modem 102 such that, when a SIM card is received in SIM card slot 118, the SIM card may be used by the modem to identify the source of the signal to be measured by apparatus 100. Additional details on selecting the signal source will be described below. A suitable SIM card slot for use with apparatus 100 will be understood by one of ordinary skill in the art from the description herein.

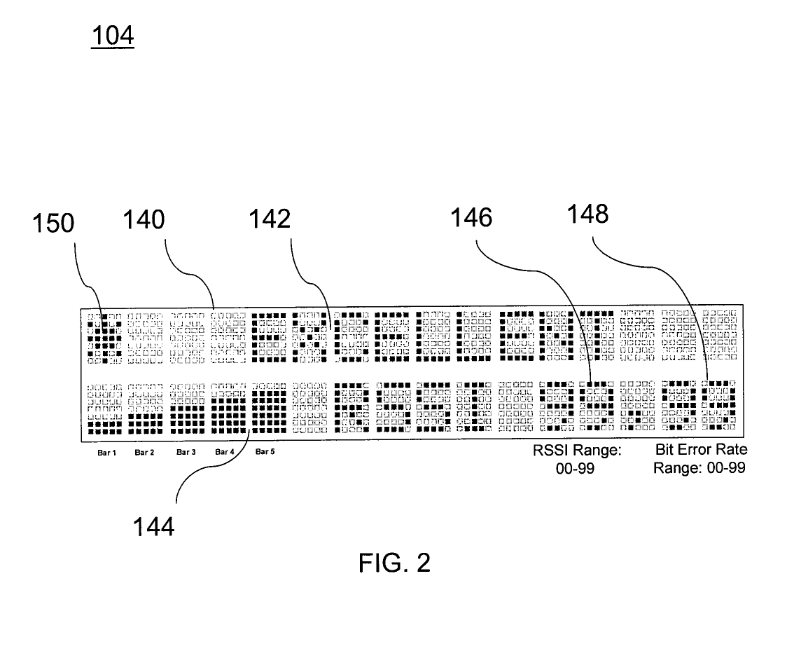

FIG. 2 depicts in greater detail an exemplary display 104 for the received signal strength indicator apparatus 100 in accordance with one aspect of the present invention. As described above, display 104 displays a received signal strength. As a general overview, display 104 includes a display area 140 having a text area 142, a bar graph area 144, a numeric area 146, a bit error rate area 148, and an activity area 150. Additional details of display 104 are provided below.

Text area 142 displays text on display area 140. In an exemplary embodiment, text area 142 displays a textual indication of the received signal strength. For example, text area 142 may display the word “EXCELLENT” when the received signal strength is high. Further, text area 142 may be configured to indicate when apparatus 100 has a low battery. For example, text area 142 may display the words “LOW BATTERY” when the battery for apparatus 100 is low on power. Additional specific textual indications will be described herein with respect to received signal strength.

Bar graph area 144 displays a bar graph on display area 140. In an exemplary embodiment, bar graph area 144 displays a bar graph corresponding to the received signal strength. For example, bar graph area 144 may display five bars when the received signal strength is high. Specific bar graph indications will be described herein with respect to received signal strength.

Numeric area 146 displays numerals on display area 140. In an exemplary embodiment, numeric area 146 displays numerals corresponding to the received signal strength. Specific numeral indications will be described herein with respect to received signal strength.

Bit error rate area 148 also displays numerals on display area 140. In an exemplary embodiment, bit error rate area 148 displays numerals corresponding to the bit error rate of the received signal. The bit error rate is a measurement of the transmission quality of the received signal. As used herein, the bit error rate is defined as the ratio of error bits received to the total number of bits sent. Specific is bit error rate indications will be described herein with respect to received signal strength.

Activity area 150 displays a symbol on display area 140. In an exemplary embodiment, activity area 150 displays a symbol indicative of the operation of apparatus 100. When apparatus 100 is actively displaying a received signal strength, activity area 150 may display a star. The star may additionally be animated, e.g., by flashing or rotating, to indicate that apparatus 100 is actively displaying. Conversely, when apparatus 100 is in “Hold” mode, as described above, apparatus 100 may display an “H” Other symbols for display in activity area 150 will be understood by one of ordinary skill in the art from the description herein.

As described above, processor 106 may indicate the received signal strength on display 104 by text, by bar graph, or by numeral. It may be desirable to display the received signal strength in a number of ways in order to accommodate different users of apparatus 100. Below are exemplary received signal strengths, and the corresponding indications displayed on display 104.

It will be understood by one of ordinary skill in the art that modem 102 may provide to processor 106 a numeric indication of received signal strength. For example, modem 102 may generate a range of numbers, e.g., 1-100, that correspond to received signal strength. It will be understood that different modems may have different ranges corresponding to their received signal strength. For all received signals, numeric area 146 may display the received signal strength (RSS) numeric indication provided by modem 102. Additionally, for all received signals, bit error rate area 148 may display the bit error rate of the received signal. Additional exemplary displays for specific RSS numbers (provided by modem 102) are now provided. It will be understood that the specific numbers and the number of indicators provided in the following example may be selected by the manufacturer and/or operator to indicate when there is no signal, a low signal, a good signal, etc.

When RSS<8, regardless of the bit error rate, display 104 may to indicate that there is no signal. In this range, text area 142 may display “NO SIGNAL”, and bar graph area 144 may display a single, flashing bar.

When 8≦RSS<10 and the bit error rate is greater than zero, display 104 may indicate that there is a low signal. In this range, text area 142 may display “LOW”, and bar graph area 144 may display a single, solid bar.

When 8≦RSS<10 and the bit error rate equals zero, or when 10≦RSS<15 and the bit error rate is greater than zero, display 104 may indicate that there is a good signal. In this range, text area 142 may display “GOOD”, and bar graph area 144 may display two solid bars.

When 10≦RSS<15 and the bit error rate equals zero, or when 15≦RSS<20 and the bit error rate is greater than zero, display 104 may indicate that there is a very good signal. In this range, text area 142 may display “VERY GOOD”, and bar graph area 144 may display three solid bars.

When 15≦RSS<20 and the bit error rate equals zero, or when 20≦RSS<48 and the bit error rate is greater than zero, display 104 may indicate that there is a great signal. In this range, text area 142 may display “GREAT”, and bar graph area 144 may display four solid bars.

Finally, when 20≦RSS and the bit error rate equals zero, display 104 may indicate that there is an excellent signal. In this range, text area 142 may display “EXCELLENT”, and bar graph area 144 may display five solid bars.

It will be understood by one of ordinary skill in the art that the above ranges for received signal strength indications are for illustrative purposes, and are not limiting.

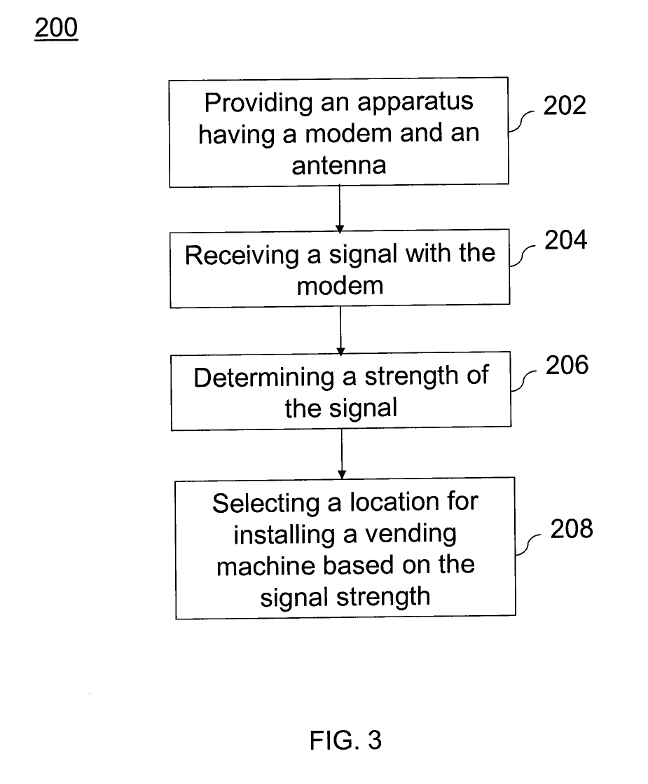

FIG. 3 is a flow chart 200 depicting exemplary steps for determining a location for installing a vending machine in accordance with an aspect of the invention. To facilitate description, the steps of FIG. 3 are described with reference to the apparatus components of FIG. 1. It will be understood by one of skill in the art from the description herein that one or more steps may be omitted and/or different components may be utilized without departing from the spirit and scope of the present invention.

In step 202, an apparatus is provided having a modem and an antenna. In an exemplary embodiment, apparatus 100 is provided. Apparatus 100 includes a modem 102 and an antenna 116. Modem 102 may correspond to a modem commonly included in a vending machine, in order to accurately determine the received signal strength at the vending machine. Similarly, antenna 116 may correspond to an antenna commonly included in a vending machine, in order to accurately determine the received signal strength at the vending machine received via the antenna.

In step 204, a signal is received with the modem. In an exemplary embodiment, modem 102 receives a signal from a source, e.g., a cell phone tower. The source may be any signal source or may be preselected, as will be described herein. Additionally, antenna 116 may receive the signal, and transmit the received signal to modem 102.

In step 206, a strength of the received signal is determined. In an exemplary embodiment, modem 102 transmits electronic data to processor 106. The electronic data represents the signal received by modem 102. Processor 106 then processes the received electronic data to determine a strength of the signal received by modem 102. Processor may continuously determine the strength of the signal as it is received by modem 102. After determining the signal strength, processor 106 may indicate the strength of the signal to a user of apparatus 100 on display 104.

In step 208, a location for installing the vending machine is selected based on the signal strength. In an exemplary embodiment, a user of apparatus 100 may determine the received signal strength in one or more potential locations for installing a vending machine. The user may then select a location having a sufficient signal strength to insure proper communication between the vending machine and the signal source. The required signal strength for a suitable location for installing a vending machine will be understood to one of ordinary skill in the art from the description herein.

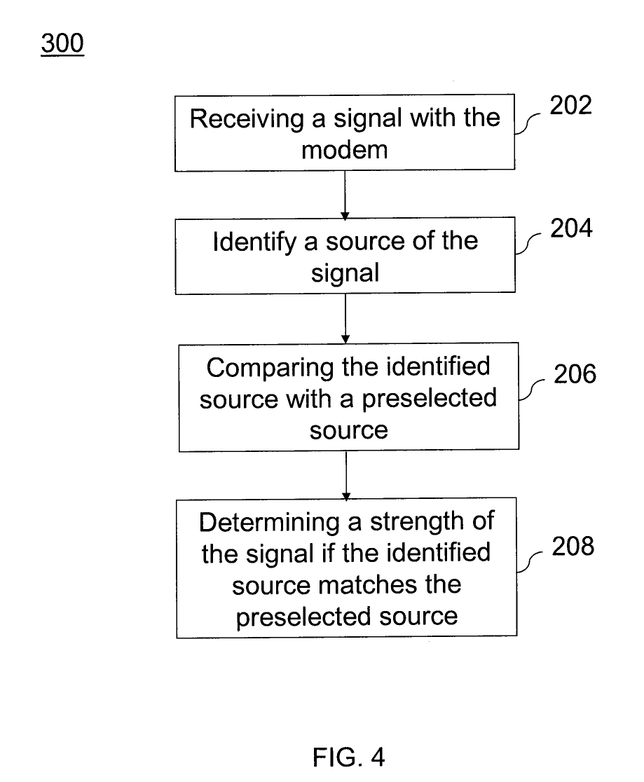

FIG. 4 is a flow chart 300 depicting exemplary steps for selecting a source of the signal for the determination of signal strength in accordance with an aspect of the present invention. To facilitate description, the steps of FIG. 4 are described with reference to the apparatus components of FIG. 1. It will be understood by one of skill in the art from the description herein that one or more steps may be omitted and/or different components may be utilized without departing from the spirit and scope of the present invention.

In step 302, a signal is received with the modem. In an exemplary embodiment, modem 102 of apparatus 100 receives a signal. Antenna 116 may receive the signal, and transmit the received signal to modem 102.

In step 304, a source of the received signal is identified. In an exemplary embodiment, processor 106 identifies the signal source. Modem 102 may transmit electronic data to processor 102, the electronic data representing the received signal. Processor 106 may then process the data to determine the source of the signal. The source of the signal may be, for example, a particular cell phone tower, or a cell phone tower corresponding to a particular cell phone network (e.g., AT&T or TMobile).

In step 306, the identified source is compared with a preselected source. In an exemplary embodiment, processor 106 compares the identified source with a preselected source. For example, processor 106 may be programmed with a preselected source, e.g., a preselected cell phone network. In an alternative embodiment, apparatus 100 may include SIM card slot 118, and a SIM card may be received in the SIM card slot. The SIM card may then be programmed with the preselected source. Processor 106 may then compare the source identified in step 304 with the preselected source. If the identified source does not match the preselected source, processor 106 may take no further action with respect to the received signal. However, if the identified source matches the preselected source, method 300 proceeds to step 308.

In step 308, a strength of the received signal is determined. In an exemplary embodiment, processor 106 then processes the received electronic data to determine a strength of the signal received by modem 102, as described above with respect to step 206. Processor 106 thereby determines the signal strength for only those signals that have been preselected either by processor 106 or by the SIM card.

One or more of the steps described above may be embodied in computer-executable instructions stored on a computer readable storage medium. The computer readable storage medium may be essentially any tangible storage medium capable of storing instructions for performance by a general or specific purpose computer such as an optical disc, magnetic disk, or solid state device, for example.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A received signal strength indicator (RSSI) apparatus comprising:
a modem configured to receive a signal;
a display;
a processor coupled to the modem and the display, the processor configured to determine a strength of the signal and to indicate the strength of the signal on the display; and
a step-up converter coupled to one or more of the modem, the processor, and the display; the step-up converter configured to step-up the voltage of a power source to power the one or more of the modem, the processor, and the display.

2. The apparatus of claim 1, further comprising:
the power source.

3. The apparatus of claim 2, wherein the power source comprises a 3V battery.

4. The apparatus of claim 2, wherein the power source comprises two AA batteries.

5. The apparatus of claim 1, wherein the step-up converter is the configured to receive a first voltage and to supply a second voltage to the one of the modem, the processor, and the display via the step-up converter, the second voltage being about 3.8 volts.

6. The apparatus of claim 5, wherein the first voltage level is between 2.9 volts and 3.1 volts and the second voltage level is between 3.7 volts and 3.9 volts.

7. The apparatus of claim 5, wherein the first voltage level is between 2.3 volts and 2.5 volts and the second voltage level is between 3.7 volts and 3.9 volts.

8. The apparatus of claim 1, wherein the step-up converter comprises a plurality of voltage step-up stages.

9. The apparatus of claim 1, wherein the processor is configurable to indicate the strength of the signal by one or more of text, by bar graph, and numeral on the display.

10. The apparatus of claim 1, wherein the processor is further configured to indicate a bit error rate of the signal on the display.

11. The apparatus of claim 1, further comprising:
a power button; and
a power relay coupled to the power button and coupled between the power source and the one or more of the modem, the processor, and the display, wherein upon actuation of the power button, the power relay couples the power source to the one or more of the modem, the processor, and the display for a predetermined period of time.

12. The apparatus of claim 1, further comprising:
a hold button coupled to the processor, wherein upon actuation of the hold button, the processor displays the strength of the signal currently indicated on the display for a predetermined period of time.

13. The apparatus of claim 1, further comprising:
an antenna coupled to the modem, wherein the modem corresponds to a vending machine modem and the antenna corresponds to a vending machine antenna.

14. The apparatus of claim 1, wherein the apparatus is a hand-held apparatus.

15. The apparatus of claim 1, wherein a source of the signal received by the modem for determination of signal strength is selected by the processor.

16. The apparatus of claim 1, further comprising:
a SIM card slot coupled to the modem for receiving a SIM card.

17. The apparatus of claim 16, wherein a source of the signal received by the modem for determination of signal strength is selected by a SIM card received in the SIM card slot.

18. A method for determining a location for installing a vending machine, comprising the steps of:
providing an apparatus having a modem and an antenna, the modem corresponding to a modem of the vending machine and the antenna corresponding to an antenna of the vending machine;
receiving a signal with the modem;
determining a strength of the signal; and
selecting the location for installing the vending machine based on the strength of the signal.

19. The method of claim 18, further comprising the step of:
selecting a source of the signal received by the modem for determination of signal strength.
